(19) United States
(12) Patent Application Publication
(10) Pub. No.: US 2021/0086715 A1
(43) Pub. Date: Mar. 25, 2021

(54) SYSTEM AND METHOD FOR MONITORING AT LEAST ONE OCCUPANT WITHIN A VEHICLE USING A PLURALITY OF CONVOLUTIONAL NEURAL NETWORKS

(71) Applicants: Aisin Technical Center of America, Inc., Nothville, MI (US); University of Iowa Research Foundation, Iowa City, IA (US)

(72) Inventors: Seungyeob Baek, Coralville, IA (US); Sehyun Chun, Iowa City, IA (US); Nima Hamidi Ghalehjegh, Iowa City, IA (US); Heesu Kim, Coralville, IA (US); Daniel V. McGehee, Iowa City, IA (US); Justin T. Kahl, Ann Arbor, MI (US); Mohammad Gudarzi, San Marcos, CA (US)

(21) Appl. No.: 17/025,440

(22) Filed: Sep. 18, 2020

Related U.S. Application Data
(60) Provisional application No. 62/905,705, filed on Sep. 25, 2019.

(51) Int. Cl. B60R 21/015; G06N 3/08; G06N 3/04

(52) U.S. Cl. CPC B60R 21/01544; G06N 3/049; G06N 3/08; B60R 21/01552

(57) ABSTRACT

A system and related method for monitoring an occupant within a vehicle using a plurality of convolutional neural networks includes a processor, a sensor having a field of view that includes at least a portion of the occupant, and a memory. The memory may include a feature map module, a key point head module, a part affinity field head module, and a seatbelt head module. The modules include instructions that cause the processor to generate a key point heat map indicating a probability that a pixel is a joint of a plurality of joints of the occupant, a part affinity field heat map indicating a pairwise relationship between at least two joints of the plurality of joints of the occupant, and a seatbelt heat map indicating a likelihood that a pixel of the input image is a seatbelt.

### CROSS-REFERENCE TO RELATED APPLICATION

This application claims the benefit of U.S. Provisional Patent Application No. 62/905,705, “System and Method for Analyzing Activity within a Cabin of a Vehicle,” filed Sep. 25, 2019, which is incorporated by reference herein in its entirety.

### TECHNICAL FIELD

The subject matter described herein relates, in general, to systems and methods for monitoring at least one occupant within a vehicle.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Vehicular crashes are routinely one of the leading causes of unintentional death. Numerous safety systems have been developed to either prevent or minimize injuries to the occupants of a vehicle involved in a crash. One way of preventing or minimizing injuries to an occupant is through the use of a seatbelt, also known as a safety belt. A seatbelt is a vehicle safety device designed to secure an occupant of a vehicle against harmful movement that may result during a collision or a sudden stop. A seatbelt may reduce the likelihood of death or serious injury in a traffic collision by reducing the force of secondary impacts with interior strike hazards and by keeping occupants positioned correctly for maximum effectiveness of the airbag (if equipped) and by preventing occupants being ejected from the vehicle in a crash or if the vehicle rolls over. They also distribute the load of the body into the three-point seatbelt thereby reducing overall injury.

However, the effectiveness of the seatbelt is based, at least in part, on the proper use of the seatbelt by the occupant. The proper use of the seatbelt includes not only the actual use of the seatbelt by the occupant but also the proper positioning of the occupant in relation to the seatbelt.

### SUMMARY

This section generally summarizes the disclosure and is not a comprehensive explanation of its full scope or all its features.

A system for monitoring at least one occupant within a vehicle using a plurality of convolutional neural networks may include one or more processors, at least one sensor in communication with the one or more processors, and a memory in communication with the one or more processors. The at least one sensor may have a field of view that includes at least a portion of the at least one occupant.

The memory may include a reception module, a feature map module, a key point head module, a part affinity field head module, and a seatbelt head module. The reception module may include instructions that, when executed by the one or more processors, causes the one or more processors to receive an input image comprising a plurality of pixels from the one or more sensors.

The feature map module may include instructions that, when executed by the one or more processors, causes the one or more processors to generate at least four levels of a feature pyramid using the input image as the input to a neural network, convolve the at least four levels of a feature pyramid to generate a reduced feature pyramid, and generate a feature map by performing at least one convolution followed by an upsampling of the reduced feature pyramid. The feature map includes key point feature maps, part affinity field feature maps, and seatbelt feature maps.

The key point head module may include instructions that, when executed by the one or more processors, causes the one or more processors to generate key point heat maps. The key point heat maps may be a key point pixel-wise probability distribution that is generated by performing at least one convolution of the reduced feature pyramid. The key point pixel-wise probability distribution may indicate a probability that a pixel is a joint of a plurality of joints of the at least one occupant located within the vehicle.

The part affinity field head module may include instructions that, when executed by the one or more processors, causes the one or more processors to generate part affinity field heat maps by performing at least one convolution of the reduced feature pyramid. The part affinity field heat map may be vector fields that indicate a pairwise relationship between at least two joints of the plurality of joints of the at least one occupant located within the vehicle.

The seatbelt head module may include instructions that, when executed by the one or more processors, causes the one or more processors to generate seatbelt heat maps. The seatbelt heat map may be a probability distribution map generated by performing at least one convolution of the reduced feature pyramid. The probability distribution map indicates a likelihood that a pixel of the input image is a seatbelt.

In another embodiment, a method for monitoring at least one occupant within a vehicle using a plurality of convolutional neural networks may include the steps of receiving an input image comprising a plurality of pixels, generating at least four levels of a feature pyramid using the input image as the input to a neural network, convolving the at least four levels of a feature pyramid to generate a reduced feature pyramid, generating a feature map that includes a key point feature map, a part affinity field feature map, and a seatbelt feature map by performing at least one convolution followed by an upsampling of the reduced feature pyramid, generating a key point heat map by performing at least one convolution of the key point feature map, generating a part affinity field heat map by performing at least one convolution of the part affinity field feature map, and generating a seatbelt heat map by performing at least one convolution of the seatbelt feature map.

The key point heat map may indicate a probability that a pixel is a joint of a plurality of joints of the at least one occupant located within the vehicle. The part affinity field heat map may indicate a pairwise relationship between at least two joints of the plurality of joints of the at least one occupant located within the vehicle. The seatbelt heat map may indicate a likelihood that a pixel of the input image is a seatbelt.

In yet another embodiment, a non-transitory computer-readable medium may include instructions for monitoring at least one occupant within a vehicle using a plurality of convolutional neural networks. The instructions, when executed by one or more processors, may cause the one or more processors to receive an input image comprising a plurality of pixels, generate at least four levels of a feature pyramid using the input image as the input to a neural network, convolve the at least four levels of a feature pyramid to generate a reduced feature pyramid, generate a feature map that includes a key point feature map, a part affinity field feature map, and a seatbelt feature map by performing at least one convolution followed by an upsampling of the reduced feature pyramid, generate a key point heat map by performing at least one convolution of the key point feature map, generate a part affinity field heat map by performing at least one convolution of the part affinity field feature map, and generate a seatbelt heat map by performing at least one convolution of the seatbelt feature map.

Like before, the key point heat map may indicate a probability that a pixel is a joint of a plurality of joints of the at least one occupant located within the vehicle. The part affinity field heat map may indicate a pairwise relationship between at least two joints of the plurality of joints of the at least one occupant located within the vehicle. The seatbelt heat map may indicate a likelihood that a pixel of the input image is a seatbelt.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a system for monitoring at least one occupant within a vehicle;

FIG. 2 illustrates a front view of a cabin of the vehicle having the system of FIG. 1;

FIG. 3 illustrates an image captured by the system of FIG. 1 and illustrating one or more skeleton points of two occupants, the relationship between the skeleton points, and the segmentation of the seatbelts utilized by the occupants as determined by the system;

FIG. 4 illustrates a block diagram of a convolutional neural network system of the system of FIG. 1;

FIG. 5 illustrates an example of an image utilized to train the convolutional neural network system of FIG. 4;

FIG. 6 illustrates an example of feature map D and the generation of feature map D′

FIG. 7 illustrates a pre-process for classifying seatbelt usage;

FIG. 8 illustrates a process for classifying seatbelt usage using a long short-term memory neural network;

FIG. 9 illustrates a method or monitoring at least one occupant within a vehicle;

FIG. 10 illustrates a method for classifying seatbelt usage; and

FIG. 11 illustrates a method for training the system of FIG. 1.

### DETAILED DESCRIPTION

In one example, a system and method for monitoring an occupant within a vehicle includes a processor, a sensor in communication with the processor, and a memory having one or more modules that cause the processor to monitor the occupant within the vehicle by utilizing information from the sensor.

Moreover, the system receives images from the sensor, which may be one or more cameras. Based on the images received from the sensor, the system can generate a feature map that includes a key point feature map, a part affinity field feature map, and a seatbelt feature map. This key point feature map is utilized by the system to output a key point heat map. The key point heat map may be a key point pixel-wise probability distribution that indicates the probability that pixels of the images are a joint of the occupant. The part affinity field feature map is utilized to generate a part affinity field heat map that indicates a pairwise relationship between the joints of the occupant, referred to as a part affinity field. The system can utilize the part affinity field and the key point pixel-wise probability distribution to generate a pose of the occupant. The seatbelt feature map is utilized to generate a seatbelt heat map that may be a probability distribution map.

The system is also able to classify if an occupant of a vehicle is properly utilizing a seatbelt. The system may utilize the key point feature map, the part affinity field feature map, the seatbelt feature map, and a feature map D′ to generate at least one probability regarding the use of the seatbelt by the one or more occupants.

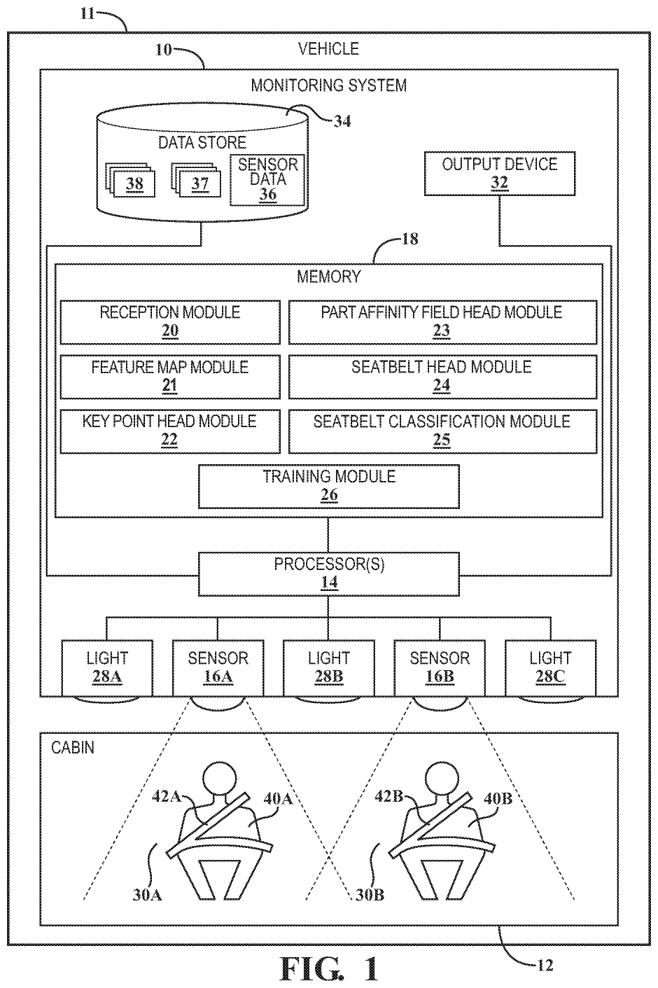

Referring to FIG. 1, illustrated is a block diagram of a monitoring system 10 for monitoring an occupant within a vehicle. In this example, the monitoring system 10 is located within a vehicle 11 that may have a cabin 12. The vehicle 11 could include any type of transport capable of transporting persons from one location to another. In one example, the vehicle 11 may be an automobile, such as a sedan, truck, sport utility vehicle, and the like. However, the vehicle 11 could also be other types of vehicles, such as tractor-trailers, construction vehicles, tractors, mining vehicles, military vehicles, amusement park rides, and the like. Furthermore, the vehicle 11 may not be limited to ground-based vehicles, but could also include other types of vehicles, such as airplanes and watercraft.

The monitoring system 10 may include processor(s) 14. The processor(s) 14 may be a single processor or may be multiple processors working in concert. The processor(s) 14 may be in communication with a memory 18 that may contain instructions to configure the processor(s) 14 to execute any one of several different methodologies disclosed herein. In one example, the memory 18 may include a reception module 20, a feature map module 21, a key point head module 22, a part affinity field head module 23, a seatbelt head module 24, a seatbelt classification module 25, and/or a training module 26. A detailed description of the modules 20-26 will be given later in this disclosure.

The memory 18 may be any type of memory capable of storing information that can be utilized by the processor(s) 14. As such, the memory 18 may be a solid-state memory device, magnetic memory device, optical memory device, and the like. In this example, the memory 18 is separate from the processor(s) 14, but it should be understood that the memory 18 may be incorporated within the processor(s) 14, as opposed to being a separate device.

The processor(s) 14 may also be in communication with one or more sensors, such as sensors 16A and/or 16B. The sensors 16A and/or 16B are sensors that can detect an occupant located within the vehicle 11 and a seatbelt utilized by the occupant. In one example, the sensors 16A and/or 16B may be cameras that are capable of capturing images of the cabin 12 of the vehicle 11. In one example, the sensors 16A and 16B are infrared cameras that are mounted within the cabin 12 of the vehicle 11 and positioned to have fields of view 30A and 30B of the cabin 12, respectively. The sensors 16A and 16B may be placed within any one of several different locations within the cabin 12. Furthermore, the fields of view 30A and 30B may overlap with each other or may be separate.

In this example, the fields of view 30A and 30B include the occupants 40A and 40B, respectively. The fields of view 30A and 30B also include the seatbelts 42A and 42B utilized by the occupants 40A and 40B, respectively. While this example illustrates two occupants—occupants 42A and 42B—the cabin 12 of the vehicle 11 may include any number of occupants. Furthermore, it should also be understood that the number of sensors utilized in the monitoring system 10 is not necessarily dependent on the number of occupants but can vary based on the configuration and layout of the cabin 12 of the vehicle 11. For example, depending on the layout and configuration of the cabin 12, only one sensor may be necessary to monitor the occupants of the vehicle 11. However, in other configurations, more than one sensor may be necessary.

As stated previously, the sensors 16A and 16B may be infrared cameras. In order to provide appropriate lighting of the cabin 12 of the vehicle 11 to allow the sensors 16A and 16B to capture images, the monitoring system 10 may also include one or more lights, such as lights 28A-28C located within the cabin 12 of the vehicle 11. In this example, the lights 28A-28C may be infrared lights that output radiation in the infrared spectrum. This type of arrangement may be favorable, as the infrared lights emit radiation that is not perceivable to the human eye and, therefore, would not be distracting to the occupants 40A and/or 40B located within the cabin 12 of the vehicle 11 when the lights 28A-28C are outputting infrared radiation.

However, the sensors 16A and/or 16B may not necessarily be cameras. As such, it should be understood that the sensors 16A and/or 16B may be any one of a number of different sensors, or combinations thereof, capable of detecting one or more occupants located within the cabin 12 of the vehicle 11 and any seatbelts utilized by the occupants. To those ends, the sensors 16A and 16B could be other types of sensors, such as light detection and ranging (LIDAR) sensors, radar sensors, sonar sensors, and other types of sensors. Furthermore, the sensors 16A and 16B may utilize different types of sensors and are not just one type of sensor. In addition, depending on the type of sensor utilized, lights 28A-28C may be unnecessary and could be omitted from the monitoring system 10.

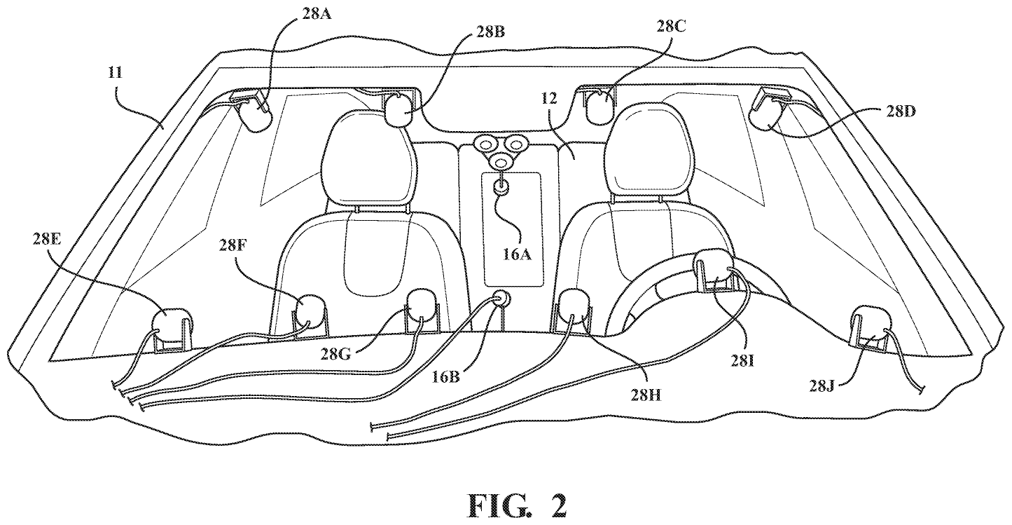

Referring to FIG. 2, an illustration of a front view of a vehicle 11 incorporating elements from the monitoring system 10 of FIG. 1 is shown. In this example, the vehicle 10 has a cabin 12. Mounted within the cabin 12 are sensors 16A and 16B. In this example, the sensors 16A and 16B are mounted vertically from one another generally along a centerline of the vehicle 11. The sensors 16A and 16B, in this example, are infrared cameras. In order to provide proper lighting to the cabin 12 of the vehicle 11, a plurality of lights 28A-28G are located at different locations throughout the cabin 12. The lights 28A-28G may be infrared lights. As stated before, infrared lights have the advantage in that the light emitted by the infrared lights is not visible to the naked eye and therefore does not provide any distraction to any of the occupants located within the cabin 12.

Referring to FIG. 1, in one embodiment, the monitoring system 10 includes a data store 34. The data store 34 is, in one embodiment, an electronic data structure such as a database that is stored in the memory 18 or another memory and that is configured with routines that can be executed by the processor(s) 14 for analyzing stored data, providing stored data, organizing stored data, and so on. Thus, in one embodiment, the data store 34 stores data used by the modules 20-26 in executing various functions. In one embodiment, the data store 34 includes sensor data 36 collected by the sensors 16A and/or 16B. The data store 34 may also include other information, such as training sets 38 that may be utilized to train the convolutional neural networks of the monitoring system 10 and/or model parameters 37 of the convolutional neural networks, as will be explained later in this specification.

The monitoring system 10 may also include an output device 32 that is in communication with the processor(s) 14. The output device 32 could be any one of several different devices for outputting information or performing one or more actions, such as activating an actuator to control one or more vehicle systems of the vehicle 11. In one example, the output device 32 could be a visual or audible indicator indicating to the occupants 40A and/or 40B that they are not properly utilizing their seatbelts 42A and/or 42B, respectively. Alternatively, the output device 32 could activate one or more actuators of the vehicle 11 to potentially adjust one or more systems of the vehicle. The systems of the vehicle could include systems related to the safety systems of the vehicle 11, the seats of the vehicle 11, and/or the seatbelts 42A and/or 42B of the vehicle 11.

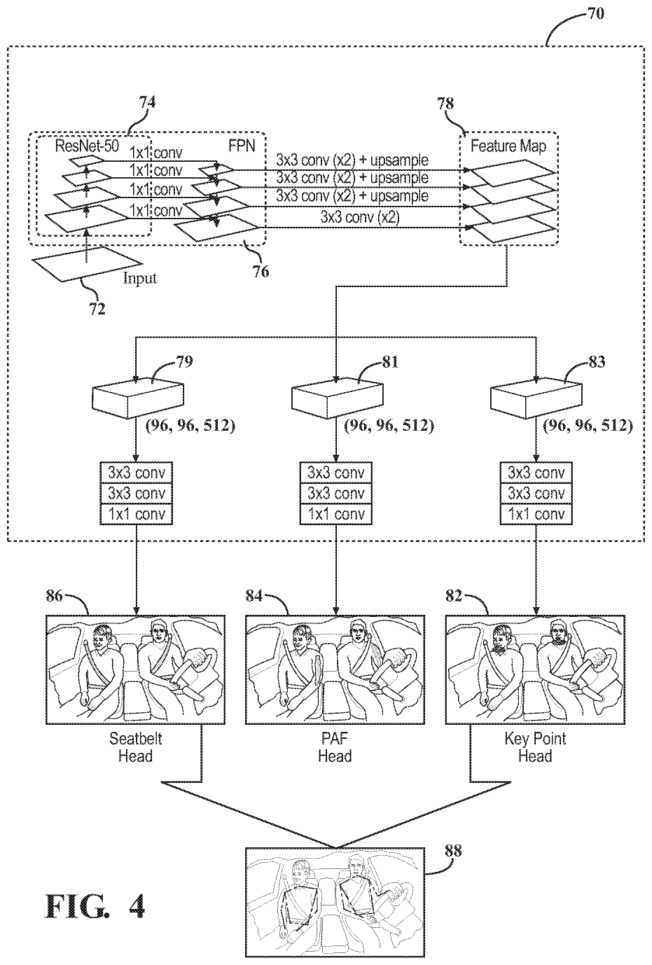

Concerning the modules, 20-26, reference will be made to FIGS. 1 and 4. Moreover, FIG. 4 illustrates a convolutional neural network system 70 having a plurality of convolutional neural networks that are incorporated within the monitoring system 10 of FIG. 1. The training of the convolutional neural network system 70 is essentially a “training phase,” wherein data sets, such as training sets 38, are collected and used to train the convolutional neural network system 70. After the convolutional neural network system 70 is trained, the convolutional neural network system 70 is placed into an “inference phase,” wherein the system 70 receives a video stream having a plurality of images, such as input image 72, processes and analyzes the video stream, and then recognizes the use of a seatbelt via a machine learning algorithm.

If a convolutional neural network is utilized, the convolutional neural network system 70 may use a feature pyramid network (FPN) backbone 76 with multi-branch detection heads, namely, a key point detection head that outputs a key point heat map 82, a part affinity field heat map 84, and a seatbelt segmentation head that outputs a seatbelt heat map 86. In an alternative embodiment, the seatbelt detection can be achieved by detecting seatbelt landmarks and connecting the landmarks, where the seatbelt landmarks can be defined as the root of the seatbelt, belt buckle, intersection between the seatbelt and the person's chest, etc.

The heat maps 82, 84, and 86 of the convolutional neural network system 70 may generate key point pixel-wise probability distribution (skeleton point), part affinity fields (PAF) vector fields, and a binary seatbelt detection mask (probability distribution map), respectively, sitting on top of the FPN backbone 76. The key point heat map 82 and the part affinity field heat map 84 may be used to parse the key point instances into human skeletons. For the parsing, the PAF mechanism may be utilized with a bipartite graph matching. The system and method of this disclosure is a single-stage architecture. For the final parsing of the skeleton, the system and method may utilize a non-maximum suppression on the detection confidence maps, which allowed the algorithm to obtain a discrete set of part candidate locations. Then, a bipartite graph was used to group each person.

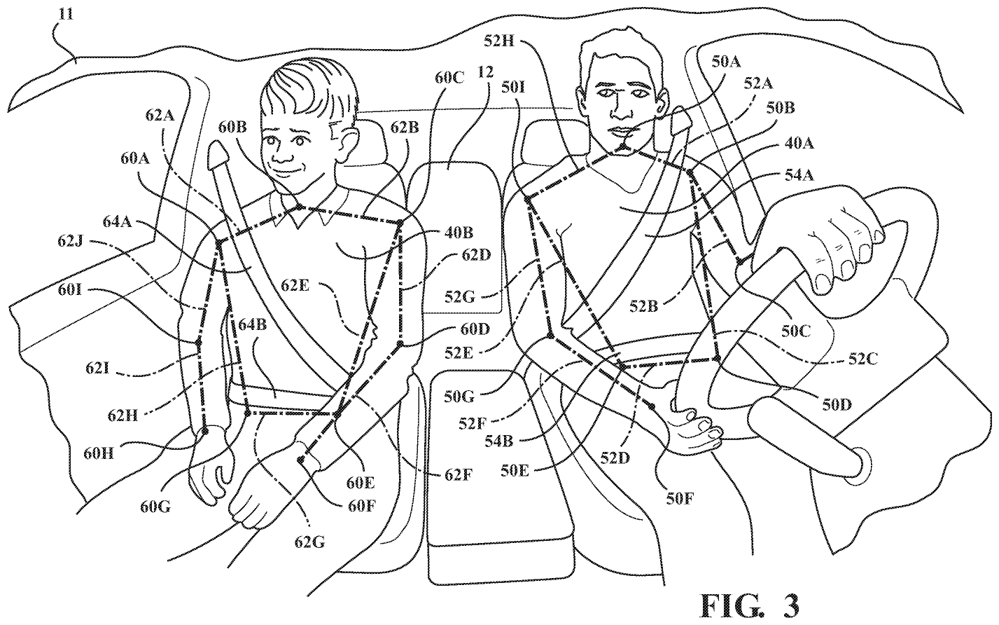

The reception module 20 may include instructions that, when executed by the processor(s) 14, cause the processor(s) 14 to receive one or more input images 72 having a plurality of pixels from the sensors 16A and/or 16B. In addition to receiving the input images 72, the reception module 20 may also cause the processor(s) 14 to actuate the lights 28A-28C to illuminate the cabin 12 of the vehicle 11. An example of the image captured by the sensors 16A and/or 16B is shown in FIG. 3.

The feature map module 21 may include instructions that, when executed by the processor(s) 14, cause the processor(s) 14 to generate at least four levels of a feature pyramid using the input image as the input to a neural network. The feature map module 21 may also cause the processor(s) 14 to convolve the at least four levels of the feature pyramid to generate a reduced feature pyramid. This may be accomplished by utilizing a 1×1 convolution.

The feature map module 21 may include instructions that, when executed by the processor(s) 14, cause the processor(s) 14 to generate a feature map 78 by performing at least one convolution followed by an upsampling of the reduced feature pyramid. The feature map 78 may include a key point feature map 83, a part affinity field feature map 81, and a seatbelt feature map 79. In one example, the neural network of the feature map module 21 may be a residual neural network, such a ResNet-50.

For example, referring to FIG. 4, the FPN backbone 76 produces a rudimentary feature pyramid for the later detection branches. The inherent structure of the ResNet-50 backbone 74 can produce multi-resolution feature maps after each residual block. For example, assume there are four residual blocks C2, C3, C4, and C5. In this example, C2, C3, C4, and C5 are sized ¼, ⅛, 1/16, and 1/32 of the original input resolution, respectively. For a given 384×384 image input implementation, the ResNet-50 backbone 74 produces four levels of feature pyramid, each sized 96×96, 48×48, 24×24, and 12×12. The number of feature maps (or channels) in the feature pyramid increases from 256 (C2) to 512 (C3), 1,024 (C4), and 2,048 (C5). These are then further convolved with 1×1 convolutions to compress the number of channels to 256. Lastly, the reduced feature pyramid further undergoes two more 3×3 convolutions and an upsampling to produce a concatenated 96×96×512 feature map 78.

Referring to FIGS. 1 and 4, the key point head module 22 may include instructions that, when executed by the processor(s) 14, causes the processor(s) 14 to generate the key point heat map 82. The key point heat map 82 may be a key point pixel-wise probability distribution that is generated by performing at least one convolution of the key point feature map 83. The key point heat map 82 indicates a probability that a pixel is a joint (skeleton point) of a plurality of joints of the occupants 40A and/or 40B located within the vehicle 11. In one example, the key point head module 22 causes the processor(s) 14 to produces ten such probability maps of the size 96×96, each of which corresponds to one of nine skeleton points to be detected and background.

In one example, the key point head module 22 may further include instructions that, when executed by the processor(s) 14, causes the processor(s) 14 to generate the key point heat map 82 by performing two 3×3 convolutions followed by 1×1 convolution of the feature map 83.

As best shown in FIG. 3, the skeleton points 50A-50I of the occupant 40A may be the position of one or more joints of the occupant 40A. For example, skeleton points 50B and 501 may indicate the left and right shoulder joints of the occupant 40A. The skeleton points 50C and 50G may indicate the left and right elbows of the occupant 40A. The same is generally true regarding the other occupant 40B located within the cabin 12.

The skeleton points 50A-50I of the occupant 40A and the skeleton points 60A-60I of the occupant 40B are merely example skeleton points. In other variations, different skeleton points may be utilized of the occupants 40A and/or 40B. Also, while the occupants 40A and 40B are located in the front row of the vehicle 11, it should be understood that the occupants may be located anywhere within the cabin 12 of the vehicle 11.

Referring to FIGS. 1 and 4, the part affinity field head module 23 may include instructions that, when executed by the processor(s) 14, causes the processor(s) 14 to generate the part affinity field heat map 84 by performing at least one convolution of the part affinity field feature map 81. The part affinity field heat map 84 may be vector fields that indicate a pairwise relationship between at least two joints of the plurality of joints of the at least one occupant located within the vehicle 11. In one example, vector fields may have a size 96×96, which encodes pairwise relationships between body joints (relationships between skeleton points).

In one example, the part affinity field head module 23 may further include instructions that, when executed by the processor(s) 14, causes the processor(s) 14 to generate the part affinity field heat map 84 by performing two 3×3 convolutions followed by a 1×1 convolution of the part affinity field feature map 81.

In the example shown in FIG. 3, the part affinity field head module 23 has identified relationships 52A-52H involving the skeleton points 50A-50I of the occupant 40A. In addition, the part affinity field head module 23 has identified relationships 62A-62J involving the skeleton points 60A-60I of the occupant 40B. Like before, the part affinity field head module 23 may cause the processor(s) 14 to determine any one of several different relationships between the skeleton points, not necessarily those shown in FIG. 3.

Referring to FIGS. 1 and 4, the seatbelt head module 24 may include instructions that, when executed by the processor(s) 14, causes the processor(s) 14 to generate a seatbelt heat map 86 by performing at least one convolution of the seatbelt feature map 79. The seatbelt heat map 86 may be a probability distribution map that indicates a likelihood that a pixel of the input image is a seatbelt. In one example, the seatbelt head module 24 may further include instructions that, when executed by the processor(s) 14, causes the processor(s) 14 to generate the seatbelt heat map 86 by performing two 3×3 convolutions followed by 1×1 convolution of the seatbelt feature map 79.

Moreover, in one example, the seatbelt heat map 86 may represent the position of the seatbelt within the one or more images. The seatbelt heat map 86 may be a probability distribution map of a size 96×96, indicating the likelihood of each pixel being a seatbelt. Each pixel-wise probability is then thresholded to generate a binary seatbelt detection mask. An output 88 is then generated, indicating the skeleton points, the relationship between the skeleton points, and segmentation of the seatbelts.

In the example shown in FIG. 3, the seatbelt being utilized by the occupant 40A has been segmented into seatbelt segment 54A and seatbelt segment 54B. The seatbelt segment 54A essentially represents the portion of the seatbelt that crosses the chest of the occupant 40A, while the seatbelt segment 54B represents the segment of the seatbelt that crosses the lap of the occupant 40A. In like manner, the seatbelt segment 64A represents the portion of the seatbelt that crosses the chest of the occupant 40B, while the seatbelt segment 64B represents the portion of the seatbelt that crosses the lap of the occupant 40B.

Referring to FIGS. 1 and 4, a seatbelt classification module 25 may include instructions that, when executed by the processor(s) 14, causes the processor(s) 14 to generate at least one probability regarding the use of the seatbelt by the one or more occupants. The probabilities may include a probability that the seatbelt is being used properly, a probability that the seatbelt is being used but improperly, and/or a probability that the seatbelt is not being used at all.

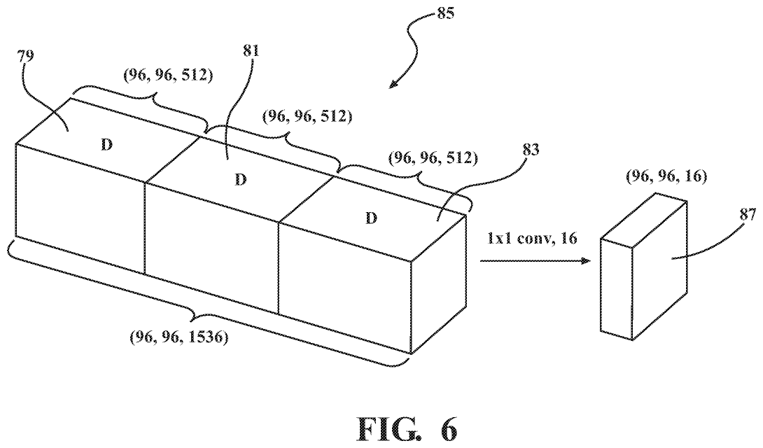

In order to perform this, the seatbelt classification module 25 causes the processor(s) 14 to generate a feature map D 85, best shown in FIG. 6. Moreover, feature map D 85 includes the seatbelt feature maps 79, the part affinity field feature map 81, and the key point feature map 83 and may have a size of 96×96×1536.

The seatbelt classification module 25 next causes the processor(s) 14 to concatenate the feature map D 85 to generate feature map D′ 87. In order to balance with the depth of other heat maps 82, 84, and 86, the feature map D 85 is converted into a 16-depth feature map D′ 87, by 1×1 convolution with 16 filters. Likewise, the seatbelt heat map 86, which may be 1-depth, may also be converted to a 10-depth heat map by duplication in the depth direction.

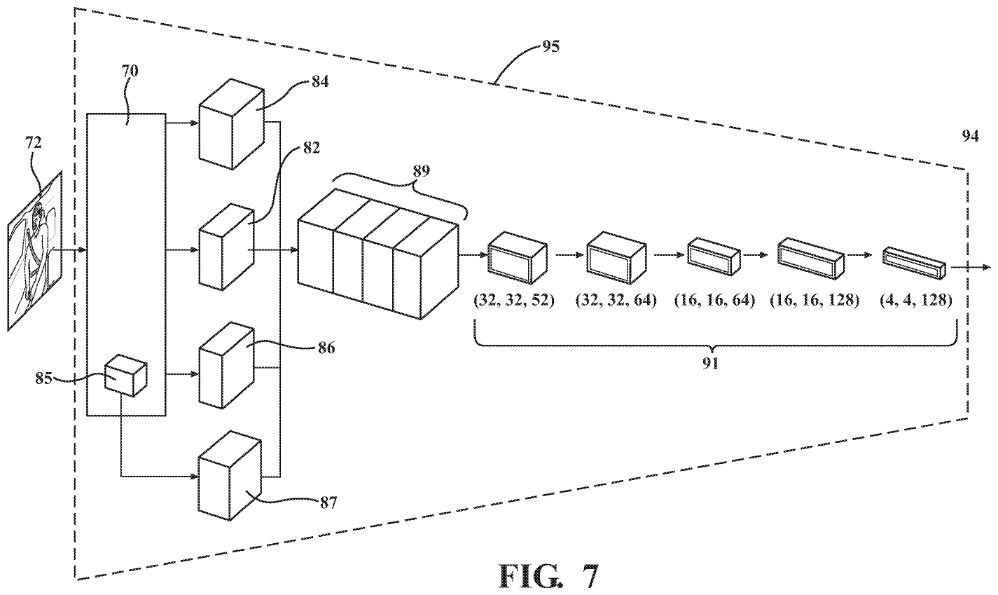

Next, the seatbelt classification module 25 causes the processor(s) 14 to generate a classifier feature map 89, as best shown in FIG. 7. Here, the classifier feature map 89 includes the heat maps 82, 84, and 86 as well as the feature map D′ 87.

The seatbelt classification module 25 then causes the processor(s) 14 to generate a classifier feature vector 94 by performing a plurality of convolutions 91 on the classifier feature map 89. In this example, the plurality of convolutions 91 include a ⅓ max pool, a 1×1 convolution, a ½ max pool, a 1×1 convolution, a ¼ average pool, and then 4×4×128 size feature map is created. The classifier feature vector 94 is generated by flattening the last feature map, which results in a 2048 length feature vector.

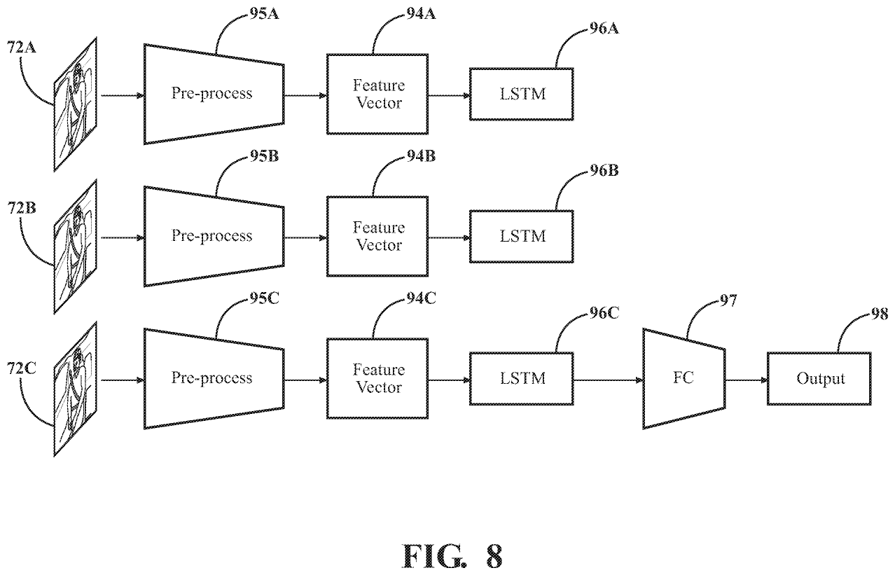

This process of generating the classifier feature vector 94 may be considered a pre-process 95 that includes the steps previously described. After the pre-process 95 is performed, a long short-term memory network (LSTM) is then utilized. Moreover, as best shown in FIG. 8, this figure illustrates three sequential input images 72A-72B being input to pre-process 95A-95C, which results in classifier feature vectors 94A-94C, respectively. As such, the classifier feature vectors 94A-94C are feature vectors taking three different moments in time because the input images 72A-72C are sequential images taken at the three different moments in time.

The seatbelt classification module 25 causes the processor(s) 14 to generate single feature vectors using an LSTM shown as LSTM repetitions 96A-96C with the classifier feature vectors 94A-94C as the input to the LSTM repetitions 96A-96C, respectively.

LSTM is a network that has a feedback connection and has the ability to process sequential data by learning long-term dependence. Therefore, it is used for tasks in which data order matter (e.g., speech recognition, handwriting recognition). The seatbelt classification module 25 utilizes this capability in view of the fact that the input of the convolutional neural network system 70 is video frame data, such as input images 72A-72C, arranged in sequential order.

The LSTM repetitions 96A-96C may output a 16-length feature vector. The output of the LSTM repetitions 96A-96C are decided by the input gate, forget gate, and output gate. The input gate decides which value will be updated, the forget gate controls the extent to which a value remains in the cell state, and the output gate decides the extent to which the value in the cell state is used to compute the output activation.

Moreover, the classifier structure of the seatbelt classification module 25 defines a window size defined according to the number of LSTMs repetition. Afterward, the input images 72A-72C in the window are converted to the distinct feature vector through the pre-processing 95A-95C. The generated feature vectors are input to the LSTM repetitions 96A-96C in order and converted into a single feature vector. This single feature vector passes through a fully connected layer 97 with three output units and softmax activation. Finally, the network outputs the probabilities corresponding to each class. In one example, there may be three classes. These classes may include a class indicating if the seatbelt is being used properly, a class indicating if the seatbelt is being used but improperly, and/or a class indicating if the seatbelt is not being used at all.

The LSTM, in this example, uses a 2048-length feature vector that is produced by pre-processing as input and outputs a 16-length feature vector. The output of the LSTM is decided by the input gate, forget gate, and output gate. The input gate decides which value will be updated, the forget gate controls the extent to which a value remains in the cell state, and the output gate decides the extent to which the value in the cell state is used to compute the output activation.

Depending on if the seatbelt is being used properly by the occupants, the seatbelt classification module 25 may include instructions that cause the processor(s) 14 to take some type of action. In one example, the action taken by the processor(s) 14 is to provide an alert to the occupants 40A and/or 40B regarding the inappropriate use of the seatbelts via the output device 32. Additionally, or alternatively, the processor(s) 14 may modify any one of the vehicle systems are subsystems in response to the inappropriate usage of the seatbelts by one or more the occupants.

As such, when in the inference phase, a machine-learning algorithm (e.g., support vector machine, artificial neural network) observes the skeletal figure of the occupant and the seatbelt detection result and classifies them into categories such as “correct-use,” “lap belt too high,” “shoulder belt misallocated,” and “non-use.” In another example, Global Positioning System (GPS) signals, vehicle acceleration/deceleration, velocity, luminous flux (illumination), etc., may additionally sense and record with the video to calibrate the video processing computer program. Fiducial landmarks (markers) may be used on the seatbelt to enhance the detection accuracy of the computer program.

The instructions and/or algorithms found in any of the modules 20-26 and/or executed by the processor(s) 14 may include the convolutional neural network system 70 trained on the data sets produce probability maps indicating (A1) body joint and landmark positions, (A2) affinity between body joints and landmarks in (A1), and (A3) the likelihood of the corresponding pixel location being the seatbelt. Moreover, a parsing module that parses from (A1) and (A2) a human skeletal figure representing the current kinematic body configuration of an occupant being detected. A segmentation module that segments from (A3) the seatbelt regions in the image.

As stated previously, the convolutional neural network system 70 of FIG. 4 may include a plurality of convolutional neural networks that are incorporated within the monitoring system 10 of FIG. 1. The plurality of convolutional neural networks of the convolutional neural network system 70 may be trained using one or more training data sets, such as training sets 38 of the data store 34. The training sets 38 may be generated using a collection protocol. The collection protocol may include activities that may be performed manually or by the processor(s) 14 instructed by the modules 20-26. These activities may include (a) collecting consent and agreement forms and prepare the occupants of the vehicle 11, (b) video capturing occupants of the vehicle 11 in various postures while vehicle 11 is not moving, including leaning against the door, stretching arms, picking up objects, etc., (c) video capturing occupants of the vehicle 11 in natural driving motions if the vehicle is moving, (d) shuffling the seating position of the subjects, changing clothes after the driving session, and repeating (b) and (c), (e) upon collection of the video data, annotating x, y coordinates of body landmark locations including neck, and left and right hips, shoulders, elbows, and wrists, for each video frame and (f) upon collection of the video data, masking and labeling seatbelt pixels, for each video frame.

The training data sets utilized to train the convolutional neural network system 70 may be based on one or more captured images that have been annotated to include known skeleton points, the relationship between skeleton points, and segmentation of the seatbelt. As such, the training module 26 may include instructions that, when executed by the processor(s) 14, cause the processor(s) to receive a training dataset including a plurality of images. Each image of the training sets 38 may include including known skeleton points of a test occupant located within a vehicle and a known relationship between the known skeleton points of the test occupant. The known skeleton points of the test occupant represent a known location of one or more joints of the test occupant. Each image may further include a known seatbelt segment, the known seatbelt segment indicating a known position of a seatbelt.

The training module 26 may include instructions that, when executed by the processor(s) 14, cause the processor(s) to determine, by the plurality of convolutional neural networks of the convolutional neural network system 70, a determined seatbelt segment based on the seatbelt heat map 86, determined skeleton points based on the key point heat map 82, and a determined relationship between the determined skeleton points based on the part affinity field heat map 84. The training module 26 may further include instructions that, when executed by the processor(s) 14, cause the processor(s) to compare the determined seatbelt segment, the determined skeleton points, and the determined relationship between the determined skeleton points with the known seatbelt segment, known skeleton points, and the known relationship between the skeleton points to determine a success ratio. The training module 26 may include instructions that, when executed by the processor(s) 14, cause the processor(s) to iteratively adjust one or more model parameters 37 of the plurality of convolutional neural networks until the success ratio falls above a threshold.

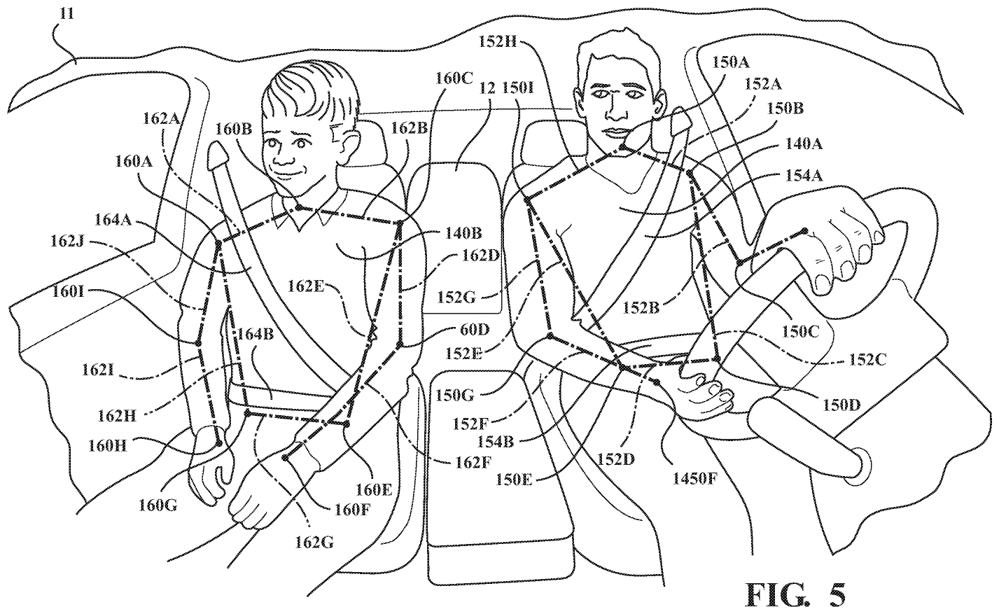

For example, referring to FIG. 5, one example of an image that is part of a training data set is shown. Here, the image of the training data set includes known skeleton points, known relationships between the skeleton points, and known seatbelt segment information. The annotation of this known information may be performed manually. In one example, the known skeleton points could include the neck, right wrist, left wrist, right elbow, left elbow, right shoulder, left shoulder, right hip, and left hip.

In this example, the image has been annotated to include known skeleton points 150A-150I, known relationships 152A-152H between known skeleton points 150A-150I, and the known seatbelt segment information 154A and 154B for the occupant 40A. In addition, the image has been annotated to include known skeleton points 160A-160I, known relationships 162A-162J between known skeleton points 160A-160I, and the known seatbelt segments 164A and 164B for the occupant 40B.

Essentially, the convolutional neural network system 70 is trained using a training data set that includes a plurality of images with known information. The training of the convolutional neural network system 70 may include a determination regarding if the convolutional neural network system 70 has surpassed a certain threshold based on a success ratio. The success ratio could be an indication of when the convolutional neural network system 70 is sufficiently trained to be able to determine the skeleton points, the relationship between the skeleton points, and seatbelt segment information. The convolutional neural network system 70 may be trained in an iterative fashion wherein the training continues until the success ratio falls above the threshold.

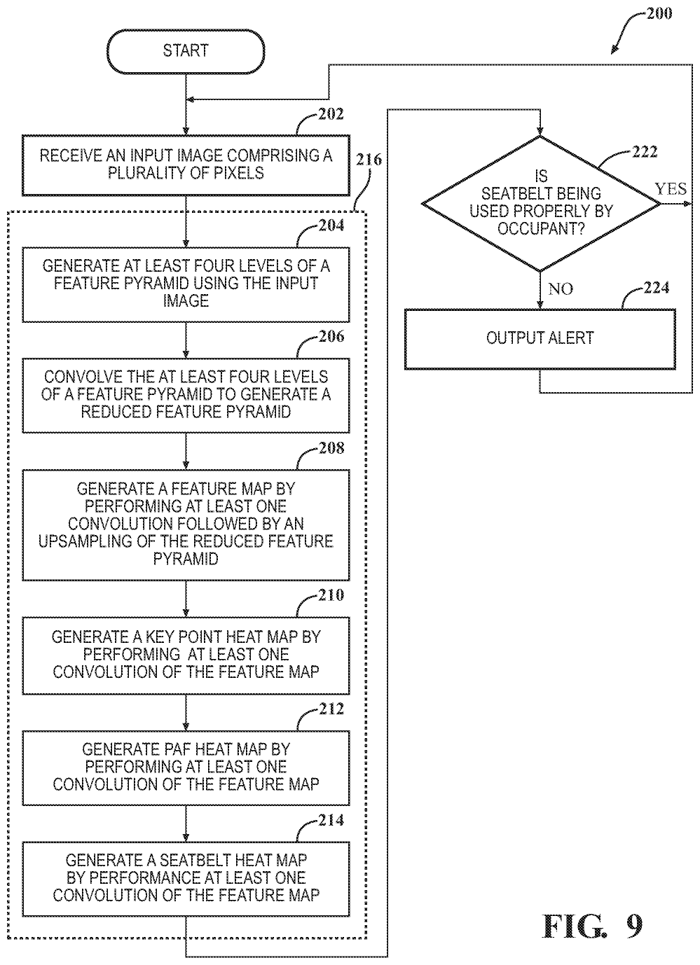

Referring to FIG. 9, a method 200 for monitoring at least one occupant within a vehicle using a plurality of convolutional neural networks is shown. The method 200 will be explained from the perspective of the monitoring system 10 of the vehicle 11 of FIG. 1 and the convolutional neural network system 70 of FIG. 4. However, the method 200 could be performed by any one of several different devices and is not merely limited to the monitoring system 10 of the vehicle 11. Furthermore, the device performing the method 200 does not need to be incorporated within a vehicle and could be incorporated within other devices as well.

The method 200 begins at step 202, wherein the reception module 20 causes the processor(s) is 14 to receive one or more input images 72 having a plurality of pixels from the sensors 16A and/or 16B. In addition to receiving the input images 72, the reception module 20 may also cause the processor(s) 14 to actuate the lights 28A-28C to illuminate the cabin 12 of the vehicle 11. An example of the image captured by the sensors 16A and/or 16B is shown in FIG. 3.

In step 204, the feature map module 21 causes the processor(s) 14 to generate at least four levels of a feature map pyramid using the input image. In step 206, the feature map module 21 causes the processor(s) 14 to convolve, utilizing a 1×1 convolution, the at least four levels of the feature pyramid to generate a reduced feature pyramid. In step 208, the feature map module 21 causes the processor(s) 14 to perform at least one convolution, followed by an upsampling of the reduced feature pyramid to generate the feature map 78. The feature map 78 may include a key point feature map 83, a part affinity field feature map 81, and a seatbelt feature map 79.

In step 210, the key point head module 22 may cause the processor(s) 14 to generate a key point heat map 82 by performing at least one convolution of the key point feature map 83. The key point heat map 82 indicates a probability that a pixel is a joint (skeleton point) of a plurality of joints of the occupants 40A and/or 40B located within the vehicle 11. In one example, the key point head module 22 causes the processor(s) 14 to produces ten such probability maps of the size 96×96, each of which corresponds to one of nine skeleton points to be detected and background. This step may also include generating the key point heat map 82 by performing two 3×3 convolutions followed by 1×1 convolution of the feature map 78.

In step 212, the part affinity field head module 23 causes the processor(s) 14 to generate a part affinity field heat map 84 by performing at least one convolution of the part affinity field feature map 81. The part affinity field heat map 84 may include vector fields that indicate a pairwise relationship between at least two joints of the plurality of joints of the at least one occupant located within the vehicle 11. In one example, vector fields may have a size 96×96, which encodes pairwise relationships between body joints (relationships between skeleton points).

In step 214, the seatbelt head module 24 may cause the processor(s) 14 to generate a seatbelt heat map 86 by performing at least one convolution of the seatbelt feature map 79. The seatbelt heat map 86 may be a probability distribution that indicates a likelihood that a pixel of the input image is a seatbelt. In one example, step 214 may generate the seatbelt heat map 86 by performing two 3×3 convolutions followed by 1×1 convolution of the feature map 78.

Moreover, in one example, the seatbelt heat map 86 may represent the position of the seatbelt within the one or more images. The seatbelt heat map 86 may be a probability distribution map of a size 96×96, indicating the likelihood of each pixel being a seatbelt. Each pixel-wise probability is then thresholded to generate a binary seatbelt detection mask. An output 88 is then generated, indicating the skeleton points, the relationship between the skeleton points, and segmentation of the seatbelts.

It should be noted that steps 204-214 of the method 200 essentially generate the heat maps 82, 84, and 86 of the convolutional neural network system 70. For simplicity regarding the later description of the training of the convolutional neural network system 70, steps 204-214 will be referred to collectively as method 216.

In step 222, the seatbelt classification module 25 may cause the processor(s) 14 to determine when a seatbelt of the vehicle is properly used by the occupant 40A and/or 40B. If the seatbelt is using properly by the occupant, the method 200 either ends or returns to step 202 and begins again. Otherwise, the method proceeds to step 224, where an alert is outputted to the occupants 40A and/or 40B regarding the inappropriate use of the seatbelts via the output device 32. Thereafter, the method 200 either ends or returns to step 202.

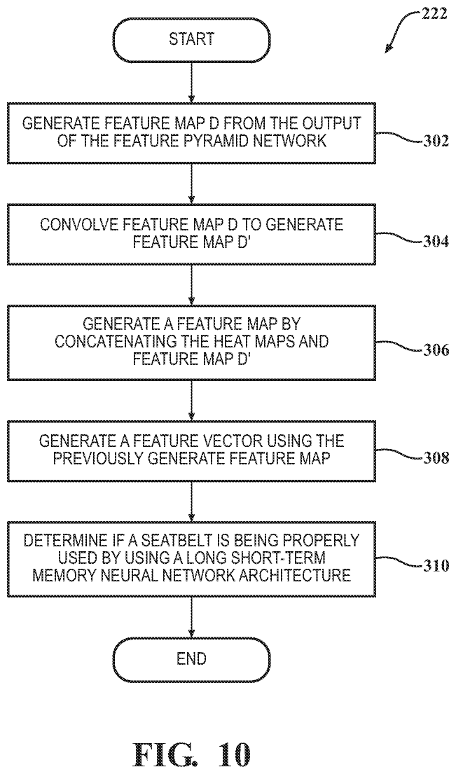

The step 222 of determining when a seatbelt of the vehicle is properly used is illustrated in more detail in FIG. 10. Here, in step 302, the seatbelt classification module 25 may cause the processor(s) 14 to generate feature map D 85 by concatenating the seatbelt feature map 79, the part affinity field feature map 81, and the key point feature map 83 and may have a size of 96×96×1526.

Next, in step 304, the seatbelt classification module 25 may cause the processor(s) 14 to reduce the feature map D 85 to generate feature map D′ 87. In order to balance with the depth of other heat maps 82, 84, and 86, the feature map D 85 is converted into a 16-depth feature map D′ 87, by 1×1 convolution with 16 filters.

In step 306, the seatbelt classification module 25 may cause the processor(s) 14 to generate a classifier feature map 89, as best shown in FIG. 7. Here, the classifier feature map 89 includes the heat maps 82, 84, and 86 as well as the feature map D′ 87.

In step 308, the seatbelt classification module 25 may cause the processor(s) 14 to generate a classifier feature vector 94 by performing a plurality of convolutions 91 on the classifier feature map 89. In this example, the plurality of convolutions 91 include a ⅓ max pool, a 1×1 convolution, a ½ max pool, a 1×1 convolution, a ¼ average pool, and then 4×4×128 size feature map is created. The classifier feature vector 94 is generated by flattening the last feature map, which results in a 2048 length feature vector.

In step 310, the seatbelt classification module 25 may cause the processor(s) 14 to determine if the seatbelt is being used properly by using an LSTM network. Here LSTM repetitions 96A-96C may output a 16-length feature vector. The LSTM, in this example, uses a 2048-length feature vector that is produced by pre-processing as input and outputs a 16-length feature vector.

This single feature vector passes through a fully connected layer 97 with three output units and softmax activation. Finally, the network outputs the probabilities corresponding to each class. In one example, there may be three classes. These classes may include a class indicating if the seatbelt is being used properly, a class indicating if the seatbelt is being used but improperly, and/or a class indicating if the seatbelt is not being used at all.

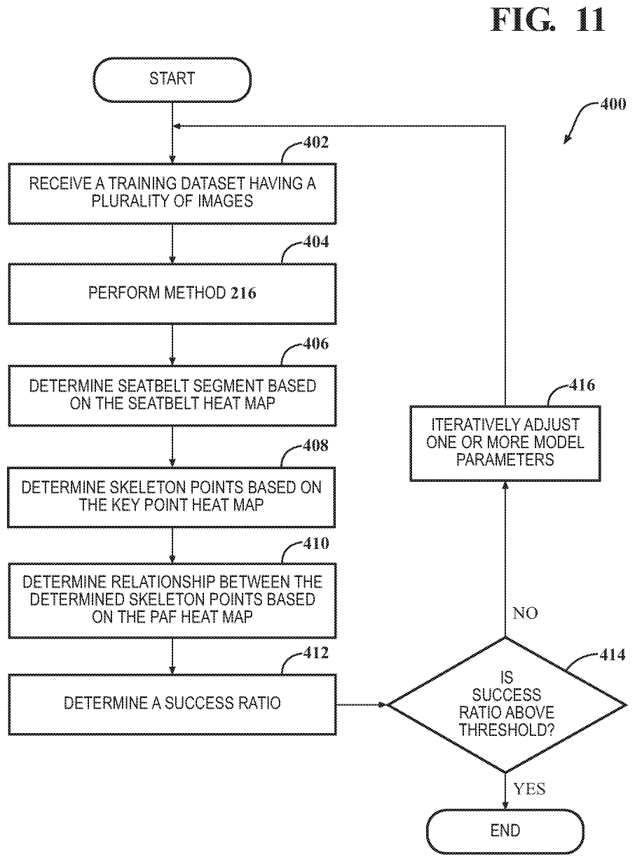

Referring to FIG. 11, a method 400 for training a monitoring system is shown. The method 300 will be explained from the perspective of the monitoring system 10 of the vehicle 11. However, the method 400 could be performed by any one of several different devices and is not merely limited to the monitoring system 10 of the vehicle 11. Furthermore, the device performing the method 300 does not need to be incorporated within a vehicle and could be incorporated within other devices as well.

In step 402, the reception module 20 causes the processor(s) is 14 to receive one or training sets 38 of images having a plurality of pixels. For example, referring to FIG. 5, one example of an image that is part of a training data set is shown. Here, the image of the training data set includes known skeleton points, known relationships between the skeleton points, and known seatbelt segment information. The annotation of this known information may be performed manually. In one example, the known skeleton points could include the neck, right wrist, left wrist, right elbow, left elbow, right shoulder, left shoulder, right hip, and left hip.

In step 404, the method 400 performs the method 216 of FIG. 7. Essentially, the method 216 of FIG, 7 generates the key point heat map 82, the part affinity field heat map 84, and the seatbelt heat map 86 for the training sets received in step 302. As such, in steps 406, 408, and 410, the training module 26 may cause the processor(s) 14 to determine, by the plurality of convolutional neural networks of the convolutional neural network system 70, a determined seatbelt segment based on the probability distribution map, determined skeleton points based on the key point pixel-wise probability distribution and a determined relationship between the determined skeleton points based on the vector fields, respectively.

In step 412, the training module 26 may cause the processor(s) 14 to compare the determined seatbelt segment, the determined skeleton points, and the determined relationship between the determined skeleton points with the known seatbelt segment, known skeleton points, and the known relationship between the skeleton points to determine a success ratio. In step 414, the training module 26 may cause the processor(s) 14 to determine if the success ratio is above the threshold. The success ratio could be an indication of when the convolutional neural network system 70 is sufficiently trained to be able to determine the skeleton points, the relationship between the skeleton points, and seatbelt segment information. The convolutional neural network system 70 may be trained in an iterative fashion wherein the training continues until the success ratio falls above the threshold.

If the success ratio is above a certain threshold, the method 400 may end. Otherwise, the method proceeds to step 416, where the training module 26 may cause the processor(s) 14 to iteratively adjust one or more model parameters 37 of the plurality of convolutional neural networks. Thereafter, the method 300 begins again at step 402, and continually adjusting the one or more model parameters until the success ratio is above a certain threshold, indicating that the monitoring system 10 is adequately trained.

It should be appreciated that any of the systems described in this specification can be configured in various arrangements with separate integrated circuits and/or chips. The circuits are connected via connection paths to provide for communicating signals between the separate circuits. Of course, while separate integrated circuits are discussed, in various embodiments, the circuits may be integrated into a common integrated circuit board. Additionally, the integrated circuits may be combined into fewer integrated circuits or divided into more integrated circuits.

In another embodiment, the described methods and/or their equivalents may be implemented with computer-executable instructions. Thus, in one embodiment, a non-transitory computer-readable medium is configured with stored computer-executable instructions that, when executed by a machine (e.g., processor, computer, and so on), cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional, and/or alternative methodologies can employ additional blocks that are not illustrated.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, other magnetic medium, an ASIC, a graphics processing unit (GPU), a CD, other optical medium, a RAM, a ROM, a memory chip or card, a memory stick, and other media from which a computer, a processor or other electronic device can read. In the context of this document, a computer-readable storage medium may be any tangible medium that can contain or store a program for use by or in connection with an instruction execution system, apparatus, or device.

The following includes definitions of selected terms employed herein. The definitions include various examples and/or forms of components that fall within the scope of a term, and that may be used for various implementations. The examples are not intended to be limiting. Both singular and plural forms of terms may be within the definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, may include one or more CMOS gates, combinations of gates, or other circuit components. Where multiple modules are described, one or more embodiments may include incorporating the multiple modules into one physical module component. Similarly, where a single module is described, one or more embodiments distribute the single module between multiple physical components.

Additionally, module, as used herein, includes routines, programs, objects, components, data structures, and so on that perform tasks or implement data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), as a graphics processing unit (GPU), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, R.F., etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses all possible combinations of one or more of the associated listed items. As an example, the phrase “at least one of A, B, and C” includes A only, B only, C only, or any combination thereof (e.g., A.B., A.C., BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system for monitoring at least one occupant within a vehicle using a plurality of convolutional neural networks, the system comprising:
one or more processors;
at least one sensor in communication with the one or more processors, the at least one sensor having a field of view that includes at least a portion of the at least one occupant; and
a memory in communication with the one or more processors, the memory including:
a reception module having instructions that when executed by the one or more processors causes the one or more processors to receive an input image comprising a plurality of pixels from the one or more sensors,
a feature map module having instructions that when executed by the one or more processors causes the one or more processors to generate at least four levels of a feature pyramid using the input image as an input to a neural network, convolve the at least four levels of a feature pyramid to generate a reduced feature pyramid, and generate a feature map by performing at least one convolution followed by an upsampling of the reduced feature pyramid, the feature map having a key point feature map, a part affinity field feature map, and a seatbelt feature map,
a key point head module having instructions that when executed by the one or more processors causes the one or more processors to generate a key point heat map, the key point heat map being a key point pixel-wise probability distribution by performing at least one convolution of the key point feature map, the key point pixel-wise probability distribution indicating a probability that a pixel is a joint of a plurality of joints of the at least one occupant located within the vehicle,
a part affinity field head module having instructions that when executed by the one or more processors causes the one or more processors to generate a part affinity field heat map by performing at least one convolution of the part affinity field feature map, the part affinity field heat map being vector fields indicating a pairwise relationship between at least two joints of the plurality of joints of the at least one occupant located within the vehicle, and
a seatbelt head module having instructions that when executed by the one or more processors causes the one or more processors to generate a seatbelt heat map, the seatbelt heat map being a probability distribution map by performing at least one convolution of the seatbelt feature map, the probability distribution map indicating a likelihood that a pixel of the input image is a seatbelt.

2. The system of claim 1, wherein the neural network of the feature map module is a residual neural network.

3. The system of claim 1, wherein the feature map module further includes instructions that when executed by the one or more processors causes the one or more processors to generate the feature map by performing at least two 3×3 convolutions followed by the upsampling of the reduced feature pyramid.

4. The system of claim 1, wherein the feature map module further includes instructions that when executed by the one or more processors causes the one or more processors to generate the reduced feature pyramid by utilizing a 1×1 convolution.

5. The system of claim 1, wherein the key point head module, the part affinity field head module, and the seatbelt head module further include instructions that when executed by the one or more processors causes the one or more processors to generate the key point heat map, the part affinity field heat map, and the seatbelt heat map by performing two 3×3 convolutions followed by 1×1 convolution of the feature map.

6. The system of claim 1, further comprising a seatbelt classification module having instructions that when executed by the one or more processors cause the one or more processors to:
generate a feature map D by concatenating the key point feature map, the part affinity field feature map, and the seatbelt feature map;
reduce the feature map D to generate feature map D′;
generate a classifier feature map by concatenating the key point feature map, the part affinity field feature map, the seatbelt feature map, and the feature map D′;
generate a classifier feature vector by performing a plurality of convolutions on the classifier feature map;
generate a single feature vector using a long short-term network with the classifier feature vector and an input to the long short-term network; and
pass the single feature vector through a fully connected layer to generate at least one probability regarding the use of the seatbelt by the at least one occupant.

7. The system of claim 1, further comprising a training module having instructions that when executed by the one or more processors cause the one or more processors to:
receive a training dataset including a plurality of images, each image including known skeleton points of a test occupant located within the vehicle and a known relationship between the known skeleton points of the test occupant, the known skeleton points of the test occupant representing a known location of one or more joints of the test occupant, each image further including a known seatbelt segment, the known seatbelt segment indicating a known position of a seatbelt,
determine, by the plurality of convolutional neural networks, a determined seatbelt segment based on the seatbelt heat map, determined skeleton points based on the key point heat map and a determined relationship between the determined skeleton points based on the part affinity field heat map,
compare the determined seatbelt segment, the determined skeleton points, and the determined relationship between the determined skeleton points with the known seatbelt segment, known skeleton points, and the known relationship between the skeleton points to determine a success ratio, and
iteratively adjust one or more model parameters of the plurality of convolutional neural networks until the success ratio falls above a threshold.

8. A method for monitoring at least one occupant within a vehicle using a plurality of convolutional neural networks, the method comprising the steps of:
receiving an input image comprising a plurality of pixels;
generating at least four levels of a feature pyramid using the input image as an input to a neural network;
convolving the at least four levels of a feature pyramid to generate a reduced feature pyramid;
generating a feature map by performing at least one convolution followed by an upsampling of the reduced feature pyramid, the feature map having a key point feature map, a part affinity field feature map, and a seatbelt feature map;
generating a key point heat map, the key point heat map being a key point pixel-wise probability distribution by performing at least one convolution of the feature map, the key point pixel-wise probability distribution indicating a probability that a pixel is a joint of a plurality of joints of the at least one occupant located within the vehicle;
generating a part affinity field heat map by performing at least one convolution of the feature map, the part affinity field heat map being vector fields indicating a pairwise relationship between at least two joints of the plurality of joints of the at least one occupant located within the vehicle; and
generating a seatbelt heat map by performing at least one convolution of the feature map, the seatbelt heat map being a probability distribution map indicating a likelihood that a pixel of the input image is a seatbelt.

9. The method of claim 8, wherein the neural network is a residual neural network.

10. The method of claim 8, further comprising the step of generating the feature map by performing at least two 3×3 convolutions followed by the upsampling of the reduced feature pyramid.

11. The method of claim 8, further comprising the step of generating the reduced feature pyramid by utilizing a 1×1 convolution.

12. The method of claim 8, further comprising the step of generating the key point heat map, the part affinity field heat map, and the seatbelt heat map by performing two 3×3 convolutions followed by 1×1 convolution of the feature map.

13. The method of claim 8, further comprising the step of:
generating a feature map D by concatenating the key point feature map, the part affinity field feature map, and the seatbelt feature map;
reducing the feature map D to generate feature map D′;
generating a classifier feature map by concatenating the key point feature map, the part affinity field feature map, the seatbelt feature map, and the feature map D′;
generating a classifier feature vector by performing a plurality of convolutions on the classifier feature map;
generating a single feature vector using a long short-term network with the classifier feature vector and an input to the long short-term network; and
passing the single feature vector through a fully connected layer to generate at least one probability regarding the use of the seatbelt by the at least one occupant.

14. The method of claim 8, further comprising the steps of:
receiving a training dataset including a plurality of images, each image including known skeleton points of a test occupant located within the vehicle and a known relationship between the known skeleton points of the test occupant, the known skeleton points of the test occupant representing a known location of one or more joints of the test occupant, each image further including a known seatbelt segment, the known seatbelt segment indicating a known position of a seatbelt;
determining, by the plurality of convolutional neural networks, a determined seatbelt segment based on the seatbelt heat map, determined skeleton points based on the key point heat map and a determined relationship between the determined skeleton points based on the part affinity field heat map;
comparing the determined seatbelt segment, the determined skeleton points, and the determined relationship between the determined skeleton points with the known seatbelt segment, known skeleton points, and the known relationship between the skeleton points to determine a success ratio; and
iteratively adjusting one or more model parameters of the plurality of convolutional neural networks until the success ratio falls above a threshold.

15. A non-transitory computer-readable medium comprising instructions for monitoring at least one occupant within a vehicle using a plurality of convolutional neural networks that, when executed by one or more processors, cause the one or more processors to:
receive an input image comprising a plurality of pixels;
generate at least four levels of a feature pyramid using the input image as an input to a neural network;
convolve the at least four levels of a feature pyramid to generate a reduced feature pyramid;
generate a feature map by performing at least one convolution followed by an upsampling of the reduced feature pyramid the feature map having a key point feature map, a part affinity field feature map, and a seatbelt feature map;
generate a key point heat map, the key point heat map being a key point pixel-wise probability distribution by performing at least one convolution of the feature map, the key point pixel-wise probability distribution indicating a probability that a pixel is a joint of a plurality of joints of the at least one occupant located within the vehicle;
generate a part affinity field heat map by performing at least one convolution of the feature map, the part affinity field heat map being vector fields indicating a pairwise relationship between at least two joints of the plurality of joints of the at least one occupant located within the vehicle; and
generate a seatbelt heat map by performing at least one convolution of the feature map, the seatbelt heat map being a probability distribution map indicating a likelihood that a pixel of the input image is a seatbelt.

16. The non-transitory computer-readable medium of claim 15, wherein the neural network is a residual neural network.

17. The non-transitory computer-readable medium of claim 15, further comprising instructions that, when executed by one or more processors, cause the one or more processors to generate the feature map by performing at least two 3×3 convolutions followed by the upsampling of the reduced feature pyramid.

18. The non-transitory computer-readable medium of claim 15, further comprising instructions that, when executed by one or more processors, cause the one or more processors to perform at least one of the following:
generate the reduced feature pyramid by utilizing a 1×1 convolution; and
generate the key point pixel-wise probability distribution, the vector fields, and the probability distribution map by performing two 3×3 convolutions followed by 1×1 convolution of the feature map.

19. The non-transitory computer-readable medium of claim 15, further comprising instructions that, when executed by one or more processors, cause the one or more processors to:
generate a feature map D that includes the key point feature map, the part affinity field feature map, and the seatbelt feature map;
reduce the feature map D to generate feature map D′;
generate a classifier feature map by concatenating the key point feature map, the part affinity field feature map, the seatbelt feature map, and the feature map D′;
generate a classifier feature vector by performing a plurality of convolutions on the classifier feature map;
generating a single feature vector using a long short-term network with the classifier feature vector and an input to the long short-term network; and
pass the single feature vector through a fully connected layer to generate at least one probability regarding the use of the seatbelt by the at least one occupant.

20. The non-transitory computer-readable medium of claim 15, further comprising instructions that, when executed by one or more processors, cause the one or more processors to:
receive a training dataset including a plurality of images, each image including known skeleton points of a test occupant located within the vehicle and a known relationship between the known skeleton points of the test occupant, the known skeleton points of the test occupant representing a known location of one or more joints of the test occupant, each image further including a known seatbelt segment, the known seatbelt segment indicating a known position of a seatbelt;
determine, by the plurality of convolutional neural networks, a determined seatbelt segment based on the seatbelt heat map, determined skeleton points based on the key point heat map and a determined relationship between the determined skeleton points based on the part affinity field heat map;
compare the determined seatbelt segment, the determined skeleton points, and the determined relationship between the determined skeleton points with the known seatbelt segment, known skeleton points, and the known relationship between the skeleton points to determine a success ratio; and
iteratively adjust one or more model parameters of the plurality of convolutional neural networks until the success ratio falls above a threshold.
